(19) United States
(12) Patent Application Publication
(10) Pub. No.: US 2025/0229524 A1
(43) Pub. Date: Jul. 17, 2025

(54) LIQUID JET HEAD AND LIQUID JET RECORDING APPARATUS

(71) Applicant: Sil Printec Inc., Chiba-shi (JP)

(72) Inventor: Shunji KAWAMOTO, Chiba-shi (JP)

(21) Appl. No.: 19/016,934

(22) Filed: Jan. 10, 2025

(30) Foreign Application Priority Data
Jan. 17, 2024 (JP) 2024-005523

(51) Int. Cl. B41J 2/045; B41J 29/46

(52) U.S. Cl. CPC B41J 2/04541; B41J 2/0451; B41J 2/04581; B41J 29/46

(57) ABSTRACT

A liquid jet head and a liquid jet recording apparatus capable of improving the reliability are provided. The liquid jet head according to an embodiment of the present disclosure includes a jet section including a single nozzle or a plurality of nozzles configured to jet a liquid, and a single drive circuit unit or a plurality of drive circuit units configured to generate a drive signal for jetting the liquid from the nozzle based on input data supplied from an external head control unit, and output the drive signal to the jet section. The drive circuit unit includes a signal generation unit configured to generate the drive signal based on the input data, a detection unit configured to detect presence or absence of an occurrence of an abnormal state related to generation of the drive signal, and a storage unit configured to store information representing the abnormal state when the occurrence of the abnormal state is detected by the detection unit.

### RELATED APPLICATIONS

This application claims priority to Japanese Patent application No. JP2024-005523, filed on Jan. 17, 2024, the entire content of which is incorporated herein by reference.

### BACKGROUND OF THE INVENTION

### 1. Field of the Invention

The present disclosure relates to a liquid jet head and a liquid jet recording apparatus.

### 2. Description of the Related Art

Liquid jet recording apparatuses equipped with liquid jet heads are used in a variety of fields, and a variety of types of liquid jet heads have been developed. Further, methods of the data transmission in the liquid jet heads have been proposed.

In such a liquid jet head, in general, it is required to improve the reliability.

Therefore, it is desirable to provide a liquid jet head and a liquid jet recording apparatus capable of improving the reliability.

### SUMMARY OF THE INVENTION

The liquid jet head according to an embodiment of the present disclosure includes a jet section including a single nozzle or a plurality of nozzles configured to jet a liquid, and a single drive circuit unit or a plurality of drive circuit units configured to generate a drive signal for jetting the liquid from the nozzle based on input data supplied from an external head control unit, and output the drive signal to the jet section. The drive circuit unit includes a signal generation unit configured to generate the drive signal based on the input data, a detection unit configured to detect presence or absence of an occurrence of an abnormal state related to generation of the drive signal, and a storage unit configured to store information representing the abnormal state when the occurrence of the abnormal state is detected by the detection unit.

A liquid jet recording apparatus according to an embodiment of the present disclosure includes the liquid jet head according to an embodiment of the present disclosure, and the head control unit.

According to the liquid jet head and the liquid jet recording apparatus according to an embodiment of the disclosure, it becomes possible to enhance the reliability.

### BRIEF DESCRIPTION OF THE DRAWINGS

FIG. 1 is a block diagram showing an outline configuration example of a liquid jet apparatus according to an embodiment of the present disclosure.

FIG. 2 is a block diagram showing a configuration example of each of drive circuit units in a liquid jet head shown in FIG. 1.

FIG. 3 is a timing chart schematically showing an operation example in each of the drive circuit units shown in FIG. 2.

FIG. 4 is a timing chart schematically showing a part of the operation example shown in FIG. 3 in an enlarged manner.

FIG. 5 is a timing chart schematically showing an operation example in a whole of the liquid jet head shown in FIG. 1.

FIG. 6 is a diagram showing timing charts schematically illustrating an operation example related to normal times and an operation example in abnormal times according to Comparative Example 1, respectively.

FIG. 7 is a diagram showing timing charts schematically illustrating operation examples in abnormal times according to Comparative Examples 2, 3, respectively.

FIG. 8 is a diagram showing timing charts schematically illustrating operation examples in abnormal times according to Practical Examples 1, 2, respectively.

FIG. 9 is a timing chart schematically illustrating an operation example in abnormal times according to Practical Examples 3.

### DETAILED DESCRIPTION OF THE PREFERRED EMBODIMENTS

An embodiment of the present disclosure will hereinafter be described in detail with reference to the drawings. It should be noted that the description will be presented in the following order.
1. Embodiment (an example when performing data transmission using a single serial data signal)
2. Modified Examples (an example of the case of other data transmission, and so on)

### 1. Embodiment

### [Configuration of Printer 3]

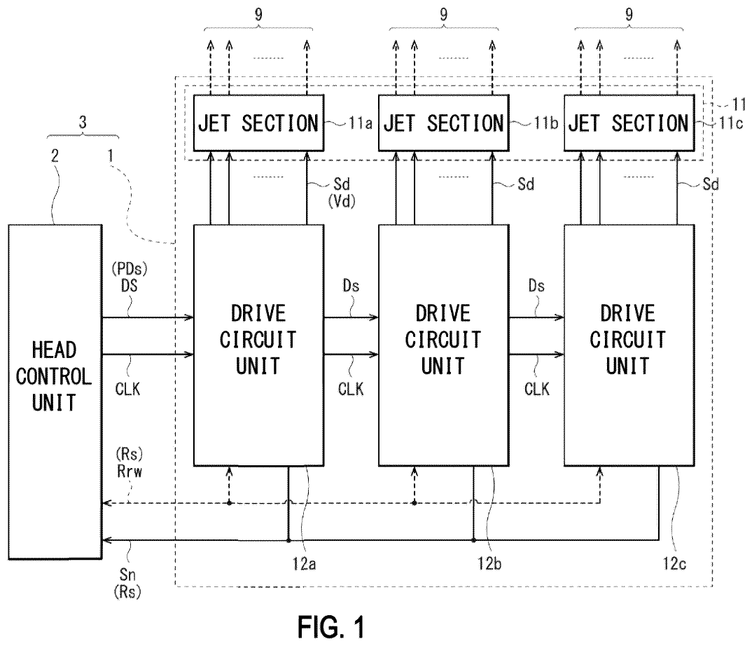

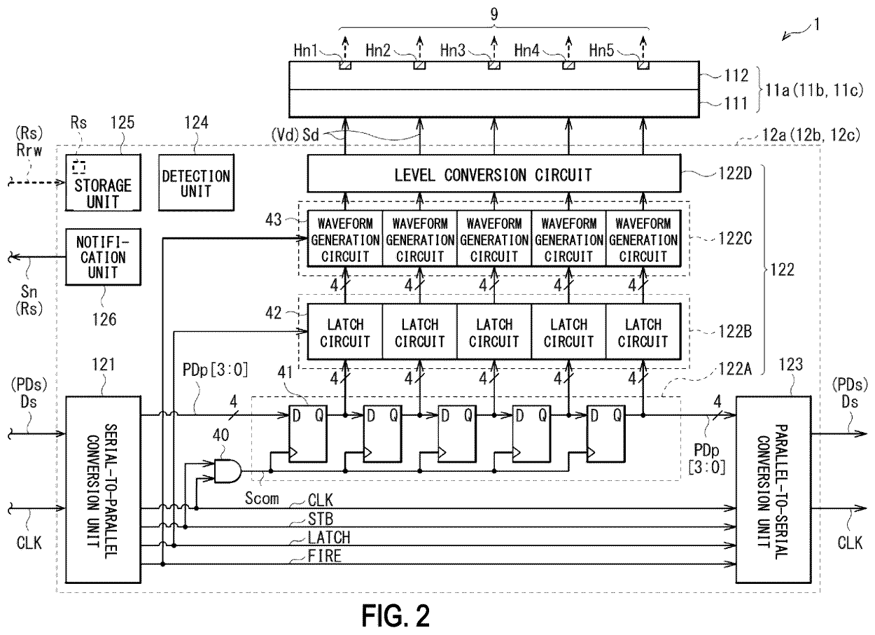

FIG. 1 is a block diagram showing an outline configuration example of a printer 3 as a liquid jet recording apparatus according to an embodiment of the present disclosure. Further, FIG. 2 is a block diagram showing a configuration example of each of drive circuit units (drive circuit units 12a, 12b, and 12c described later) in an inkjet head 1 as a liquid jet head shown in FIG. 1. It should be noted that in FIG. 1 and FIG. 2 described above, “/N” (N: an integer no smaller than 2) described on a wiring line of a signal represents the number of wiring lines. Further, a scale size of each of the members is accordingly altered so that the member is shown in a recognizable size in the drawings used in the description of the present specification.

The printer 3 is an inkjet printer for performing recording (printing) of images, characters, and the like on a recording target medium (e.g., recording paper) using ink 9 described later. As shown in FIG. 1, the printer 3 is provided with the inkjet head 1 and a head control unit 2.

It should be noted that the inkjet head 1 corresponds to a specific example of a “liquid jet head” in the present disclosure, and the printer 3 corresponds to a specific example of a “liquid jet recording apparatus” in the present disclosure. Further, the ink 9 corresponds to a specific example of a “liquid” in the present disclosure.

### (A. Head Control Unit 2)

The head control unit 2 is for supplying the inkjet head 1 with a variety of types of information (data). Specifically, as shown in FIG. 1, the head control unit 2 is arranged to supply a single serial data signal Ds and a single clock signal CLK to the drive circuit unit 12a (the drive circuit unit in the anteriormost stage) described later in the inkjet head 1.

Here, these serial data signal Ds and clock signal CLK are each arranged to be transmitted with, for example, low voltage differential signaling (LVDS). Thus, it is arranged that the high-speed transmission with a small-amplitude signal becomes possible, and a performance of removal of common-mode noise is enhanced by using the differential signal. Further, as shown in FIG. 1, the serial data signal Ds and the clock signal CLK are each arranged to be transmitted with a single signal line. Further, the serial data signal Ds is synchronized with the clock signal CLK, and includes serial data corresponding to 7 bits in each clock period (a period of a single cycle T described later). However, the size of the serial data is not limited to 7 bits, and may be a plurality of bits other than 7 bits.

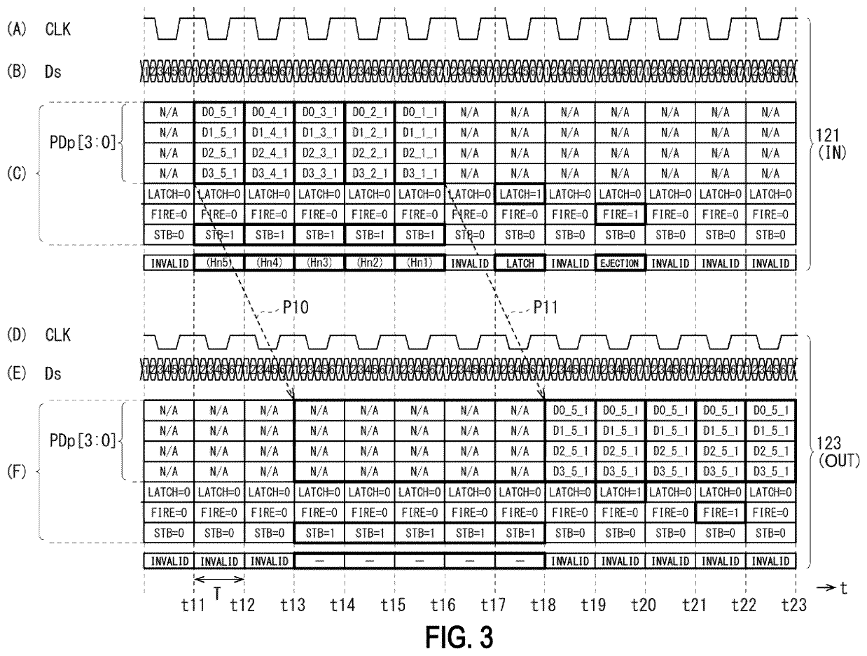

Further, in the present embodiment, in the serial data signal Ds, an m-bit (m: an integer not smaller than 2; 4 bits in this example) serial pixel data signal PDs and other signals are multiplexed as described later in detail (see FIG. 3). Specifically, in this example, the serial data signal Ds is configured including a latch signal LATCH, a firing signal (an ejection start signal) FIRE, and a strobe signal STB (STROBE) together with the 4-bit serial pixel data signal PDs. Further, in the present embodiment, it is arranged that the serial pixel data signal PDs individually defined in accordance with all the plurality of nozzles described later in the inkjet head 1 is included in such a single serial data signal Ds.

It should be noted that the serial data signal Ds and the clock signal CLK described above each correspond to a specific example of “input data” in the present disclosure.

### (B. Inkjet Head 1)

The inkjet head 1 is a head which jets (ejects) the ink 9 shaped like a droplet from a plurality of nozzles described later to the recording target medium as represented by the dotted arrows in FIG. 1 and FIG. 2 to thereby perform recording of images, characters, and so on. As shown in FIG. 1, the inkjet head 1 is provided with a jet section 11, a plurality of drive circuit units (three drive circuit units 12a, 12b, and 12c in this example). It should be noted that it is arranged that the ink 9 is supplied to the inside of such an inkjet head 1 from an inside of an ink tank not shown via a supply tube and so on.

### (B-1. Jet Section 11)

As shown in FIG. 1, the jet section 11 is configured including a plurality of (three in this example) jet sections 11a, 11b, and 11c. The jet sections 11a, 11b, and 11c are arranged to individually correspond respectively to the drive circuit units 12a, 12b, and 12c described above. These jet sections 11a, 11b, and 11c each include the plurality of nozzles described above, and are each arranged to jet the ink 9 from these nozzles in accordance with the drive signal Sd (drive voltage Vd) individually supplied from the drive circuit units 12a, 12b, and 12c.

As shown in, for example, FIG. 2, such jet sections 11a, 11b, and 11c are each configured including a piezoelectric actuator (an actuator plate) 111 and a nozzle plate 112.

The nozzle plate 112 is a plate formed of a film material such as polyimide, or a metal material, and has the plurality of nozzles (five nozzle holes Hn1 to Hn5 in this example; hereinafter collectively referred to as nozzle holes Hn) described above as shown in FIG. 2. These nozzle holes Hn1 to Hn5 are formed, for example, side by side on a straight line (in a row) at predetermined intervals, and each have, for example, a circular shape.

It should be noted that these nozzle holes Hn1 to Hn5 (the plurality of nozzle holes Hn) each correspond to a specific example of a “nozzle” in the present disclosure.

The piezoelectric actuator 111 is a plate formed of a piezoelectric material such as PZT (lead zirconate titanate). The piezoelectric actuator 111 is provided with a plurality of channels (pressure chambers) not shown. These channels are each a part for applying pressure to the ink 9, and are arranged side by side so as to be parallel to each other at predetermined intervals. Each of the channels is partitioned with drive walls (not shown) formed of a piezoelectric body, and forms a groove part having a recessed shape in a cross-sectional view.

In such channels, there exist ejection channels for ejecting the ink 9, and dummy channels (non-ejection channels) which do not eject the ink 9. In other words, it is arranged that the ejection channels are filled with the ink 9 on the one hand, but the dummy channels are not filled with the ink 9 on the other hand. It should be noted that it is arranged that the ink 9 is supplied to the inside of the ejection channel via the supply tube described above, a predetermined flow path, and so on. Further, it is arranged that each of the ejection channels is communicated with the nozzle hole Hn in the nozzle plate 112 described above on the one hand, but each of the dummy channels is not communicated with the nozzle hole Hn on the other hand. The ejection channels and the dummy channels described above are alternately arranged side by side.

On the inner side surfaces opposed to each other in the drive wall described above, there are respectively disposed drive electrodes (not shown). As the drive electrodes, there exist common electrodes disposed on the inner side surfaces facing the ejection channels, and active electrodes (individual electrodes) disposed on the inner side surfaces facing the dummy channels. These drive electrodes and the drive circuit units 12a, 12b, and 12c described later are electrically coupled to each other via a plurality of extraction electrodes (not shown) provided to a flexible board (not shown). Thus, it is arranged that the drive voltages Vd (the drive signals Sd) described above are applied from the drive circuit units 12a, 12b, and 12c to each of the drive electrodes via the flexible board (see FIG. 1 and FIG. 2).

### (B-2. Drive Circuit Units 12a, 12b, 12c)

As shown in FIG. 1, the drive circuit units 12a, 12b, and 12c are each a circuit which supplies the drive signal Sd (the drive voltages Vd) for jetting the ink 9 from each of the nozzle holes Hn to the jet sections 11a, 11b, and 11c corresponding to the drive circuit units 12a, 12b, and 12c, respectively. Specifically, the drive circuit units 12a, 12b, and 12c are each arranged so as to generate the drive signal Sd based on the serial data signal Ds and the clock signal CLK supplied from the head control unit 2 described above, and then individually output the drive signal Sd to the jet sections 11a, 11b, and 11c corresponding to the drive circuit units 12a, 12b, and 12c, respectively.

Further, as shown in FIG. 1, the plurality of drive circuit units 12a, 12b, and 12c are serially cascaded (cascade coupled) to each other in the inkjet head 1 (on a drive circuit board not shown). In other words, the number of stages of the cascade coupling of the drive circuit units 12a, 12b, and 12c in the inkjet head 1 is three. Specifically, as shown in FIG. 1, the cascade coupling from the anterior stage side toward the posterior stage side is formed in the order of the head control unit 2, the drive circuit unit 12a (the anteriormost stage), the drive circuit unit 12b, and the drive circuit unit 12b, and the drive circuit unit 12c (posteriormost stage), and it is arranged that the data transmission is performed in this order as described later in detail.

Here, such drive circuit units 12a, 12b, and 12c each have a serial-to-parallel conversion unit 121, a drive signal generation unit 122, a parallel-to-serial conversion unit 123, a detection unit 124, a storage unit 125, and a notification unit 126 as shown in, for example, FIG. 2. It should be noted that the serial-to-parallel conversion unit 121 and the drive signal generation unit 122 each correspond to a specific example of a “signal generation unit” in the present disclosure.

### (Serial-To-Parallel Conversion Unit 121)

The serial-to-parallel conversion unit 121 is a circuit which performs a predetermined serial-to-parallel conversion based on the serial data signal Ds configured including the m-bit (4-bit in this example) serial pixel data signal PDs described above and the clock signal CLK. It is arranged that the m-bit (4-bit in this example) parallel pixel data signal PDp (PDp[3:0]) is generated as shown in FIG. 2 by such serial-to-parallel conversion.

Specifically, as shown in FIG. 2, the serial-to-parallel conversion unit 121 performs such serial-to-parallel conversion to thereby generate the latch signal LATCH, the firing signal FIRE, and the strobe signal STB described above together with the 4-bit parallel pixel data signal PDp. It should be noted that it is arranged that the clock signal CLK is also output from the serial-to-parallel conversion unit 121 (see FIG. 2).

### (Drive Signal Generation Unit 122)

The drive signal generation unit 122 is for generating the drive signal Sd (the drive voltage Vd) described above for each of the nozzle holes Hn. Specifically, as shown in FIG. 2, the drive signal generation unit 122 generates such drive signals Sd based on the m-bit (4-bit in this example) parallel pixel data signal PDp, the latch signal LATCH, the strobe signal STB, and the clock signal CLK.

As shown in FIG. 2, such a drive signal generation unit 122 includes a shift register unit 122A, a latch circuit unit 122B, a waveform generation circuit unit 122C, a level conversion circuit 122D, and a logical AND circuit (AND circuit) 40.

As shown in FIG. 2, the logical AND circuit 40 is a logic circuit for generating a logical AND signal (an AND signal) Scom of the strobe signal STB and the clock signal CLK.

The shift register unit 122A is a circuit which sequentially transfers the parallel pixel data signal PDp for the plurality of nozzle holes Hn from the anterior stage side (the nozzle hole Hn1 side) toward the posterior stage side (the nozzle hole Hn5 side) so as to correspond to the drive signals Sd for the plurality of nozzle holes Hn, and then holds the parallel pixel data signal PDp (see FIG. 2). The shift register unit 122A has the same number (5 in this example) of D-FF (flip-flop) circuits 41 as the number of nozzle holes Hn, and it is made possible to hold the 4-bit parallel pixel data signal PDp in each of the D-FF circuits 41. Further, as shown in FIG. 2, it is arranged that the logical AND signal Scom generated by the logical AND circuit 40 described above is input to the D-FF circuits 41 as a shift clock when performing the sequential transfer. In other words, the shift register unit 122A is arranged to perform the sequential transfer of the parallel pixel data signal PDp in synchronization with the logic AND signal Scom described above.

As shown in FIG. 2, the latch circuit unit 122B is a circuit which holds the 4-bit parallel pixel data signal PDp for each of the nozzle holes Hn output from each of the D-FF circuits 41 in the shift register unit 122A in synchronization with the latch signal LATCH. The latch circuit unit 122B has the same number (5 in this example) of latch circuits 42 as the number of nozzle holes Hn, and it is made possible to hold the 4-bit parallel pixel data signal PDp in each of the latch circuits 42.

As shown in FIG. 2, the waveform generation circuit unit 122C is a circuit which generates a waveform signal as a basis of the drive signal Sd based on the 4-bit parallel pixel data signal PDp for each of the nozzle holes Hn output from each of the latch circuits 42 in the latch circuit unit 122B. The waveform generation circuit unit 122C has the same number (5 in this example) of waveform generation circuits 43 as the number of nozzle holes Hn, and in each of the waveform generation circuits 43, it is arranged to generate such a waveform signal in synchronization with the firing signal FIRE.

As shown in FIG. 2, the level conversion circuit 122D is a circuit which generates the drive signal Sd for each of the nozzle holes Hn based on the waveform signal for each of the nozzle holes Hn output from each of the waveform generation circuits 43 in the waveform generation circuit unit 122C. Specifically, the level conversion circuit 122D is arranged to generate the drive signal Sd having the drive voltage Vd corresponding to each of the nozzle holes Hn by performing conversion of the level (voltage value) of each of the waveform signals.

### (Parallel-to-Serial Conversion Unit 123)

The parallel-to-serial conversion unit 123 is a circuit which performs a predetermined parallel-to-serial conversion based on the m-bit (4-bit in this example) parallel pixel data signal PDp described above and the clock signal CLK. As shown in FIG. 2, due to such a parallel-to-serial conversion, it is arranged that the serial data signal Ds described above is generated (regenerated), and the serial data signal Ds and the clock signal CLK are each output to the outside of each of the drive circuit units 12a, 12b, and 12c.

Specifically, the parallel-to-serial conversion unit 123 is arranged to perform the parallel-to-serial conversion described above based on the 4-bit parallel pixel data signal PDp output from the shift register unit 122A (the D-FF circuit 41 in the posteriormost stage), the clock signal CLK, the strobe signal STB, the latch signal LATCH, and the firing signal FIRE (see FIG. 2).

Here, as shown in FIG. 1 and FIG. 2, the serial data signal Ds and the clock signal CLK output from the parallel-to-serial conversion unit 123 in the drive circuit unit located at relatively anterior stage side are each input to the serial-to-parallel conversion unit 121 in the drive circuit unit located at relatively posterior stage side. Specifically, the serial data signal Ds and the clock signal CLK output from the drive circuit unit 12a at relatively anterior stage side are each input to the drive circuit unit 12b at relatively posterior stage side. Similarly, the serial data signal Ds and the clock signal CLK output from the drive circuit unit 12b at relatively anterior stage side are each input to the drive circuit unit 12c at relatively posterior stage side. Thus, as shown in FIG. 1, it is arranged that the plurality of drive circuit units 12a, 12b, and 12c are serially cascaded (cascade coupled) to each other.

### (Detection Unit 124)

The detection unit 124 is for detecting presence or absence of an occurrence of a variety of abnormal states related to the generation of the drive signals Sd in the drive signal generation unit 122. The content of such a variety of abnormal states will be described later in detail, but as an example, a so-called “redundant trigger state” can be cited. The redundant trigger state means an abnormal state in which the drive circuit units 12a to 12c receive the input data (the serial data signal Ds and the clock signal CLK) from the head control unit 2 within the generation period of the drive signal Sd.

### (Storage Unit 125)

The storage unit 125 is a unit in which information (status register Rs) representing a variety of abnormal states described above is stored when an occurrence of such abnormal states is detected by the detection unit 124. Further, as described later in detail, it is arranged that the information of the status register stored in the storage unit 125 can be read by the head control unit 2 using a function of, for example, register read/write Rrw (see FIG. 1 and FIG. 2).

It should be noted that the status register Rs described above corresponds to a specific example of the “information representing the abnormal state” in the present disclosure.

### (Notification Unit 126)

The notification unit 126 is for giving a predetermined notification to the head control unit 2 using a notification signal Sn (an interrupt signal or the like). As an example, the notification unit 126 is arranged to notify the head control unit 2 of the information of the status register Rs stored in the storage unit 125 using the notification signal Sn.

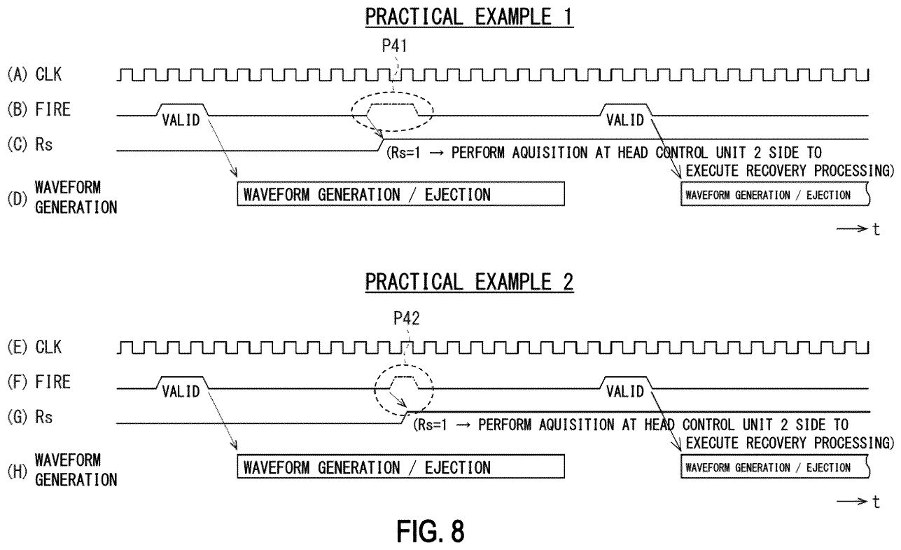

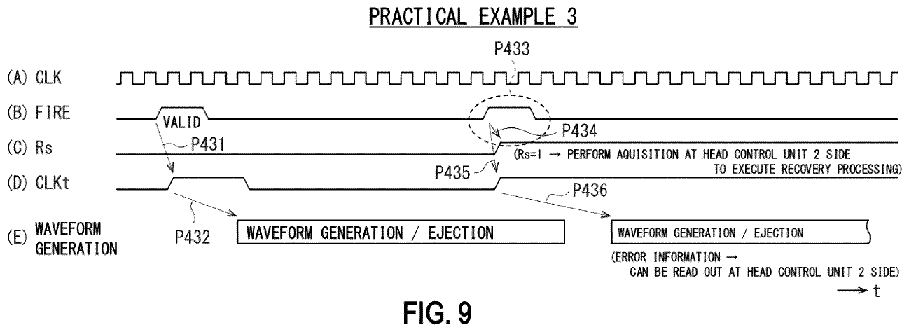

It should be noted that a detailed operation and so on in the detection unit 124, the storage unit 125, and the notification unit 126 will be described later (see FIG. 8 and FIG. 9).

### Operations and Functions/Advantages

### (A. Basic Operation of Printer 3)

In the printer 3, a recording operation (a printing operation) of images, characters, and so on to the recording target medium is performed using such a jet operation of the ink 9 by the inkjet head 1 as described below. Specifically, in the inkjet head 1 according to the present embodiment, the jet operation of the ink 9 using a shear mode is performed in the following manner. It should be noted that in the printer 3, as an initial state, the ejection channels in the piezoelectric actuators 111 of the inkjet head 1 are filled with the ink 9 in the ink tank described above via the supply tube, the predetermined flow path, and so on.

First, the drive circuit units 12a, 12b, and 12c apply the drive voltages Vd (the drive signals Sd) to the drive electrodes (the common electrodes and the active electrodes) described above in the piezoelectric actuators 111 in the jet sections 11a, 11b, and 11c corresponding thereto. Specifically, each of the drive circuit units 12a, 12b, and 12c applies the drive voltage Vd to each of the drive electrodes disposed on the pair of drive walls partitioning the ejection channel described above. Thus, the pair of drive walls each deform so as to protrude toward the dummy channel adjacent to the ejection channel.

On this occasion, it results in that the drive wall makes a flexion deformation to have a V shape centering on the intermediate position in the depth direction in the drive wall. Further, due to such a flexion deformation of the drive wall, the ejection channel deforms as if the ejection channel bulges. As described above, due to the flexion deformation caused by a piezoelectric thickness-shear effect in the pair of drive walls, the volume of the ejection channel increases. Further, by the volume of the ejection channel increasing, the ink 9 is induced into the ejection channel as a result.

Subsequently, the ink 9 induced into the ejection channel in such a manner turns to a pressure wave to propagate to the inside of the ejection channel. Then, the drive voltage Vd to be applied to the drive electrodes becomes 0 (zero) V at the timing at which the pressure wave has reached the nozzle hole Hn of the nozzle plate 112. Thus, the drive walls are restored from the state of the flexion deformation described above, and as a result, the volume of the ejection channel having once increased is restored again.

In such a manner, the pressure inside the ejection channel increases in the process that the volume of the ejection channel is restored, and thus, the ink 9 in the ejection channel is pressurized. As a result, the ink 9 having a droplet shape is ejected (see FIG. 1 and FIG. 2) toward the outside (toward the recording target medium) through the nozzle hole Hn. The jet operation (the ejection operation) of the ink 9 in the inkjet head 1 is performed in such a manner, and as a result, the recording operation of images, characters, and so on to the recording target medium is performed.

### (B. Data Transfer Operation)

Then, a data transfer operation between the head control unit 2 and the drive circuit unit 12a, and among the drive circuit units 12a, 12b, and 12c will be described in detail with reference to FIG. 3 to FIG. 5 in addition to FIG. 1 and FIG. 2.

First, as shown in FIG. 2, each of the drive circuit units 12a, 12b, and 12c in the present embodiment is provided with the serial-to-parallel conversion unit 121 and the parallel-to-serial conversion unit 123. Further, in each of the drive circuit units 12a, 12b, and 12c and the whole of the inkjet head 1, the data transfer operation is performed in the following manner.

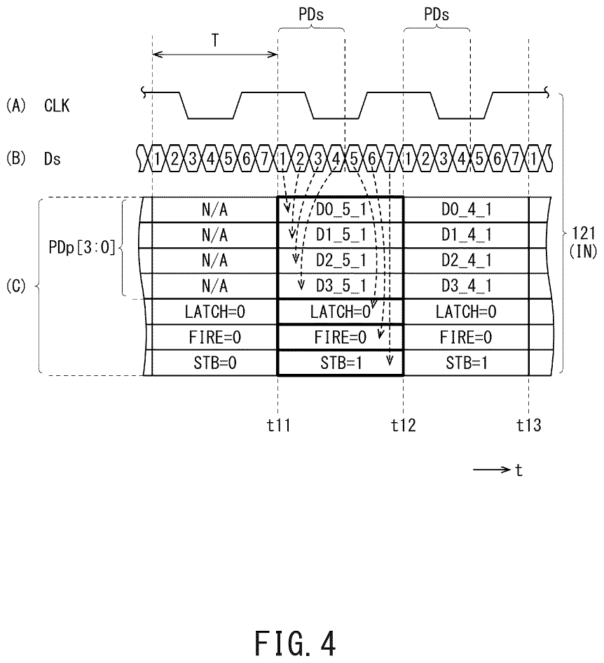

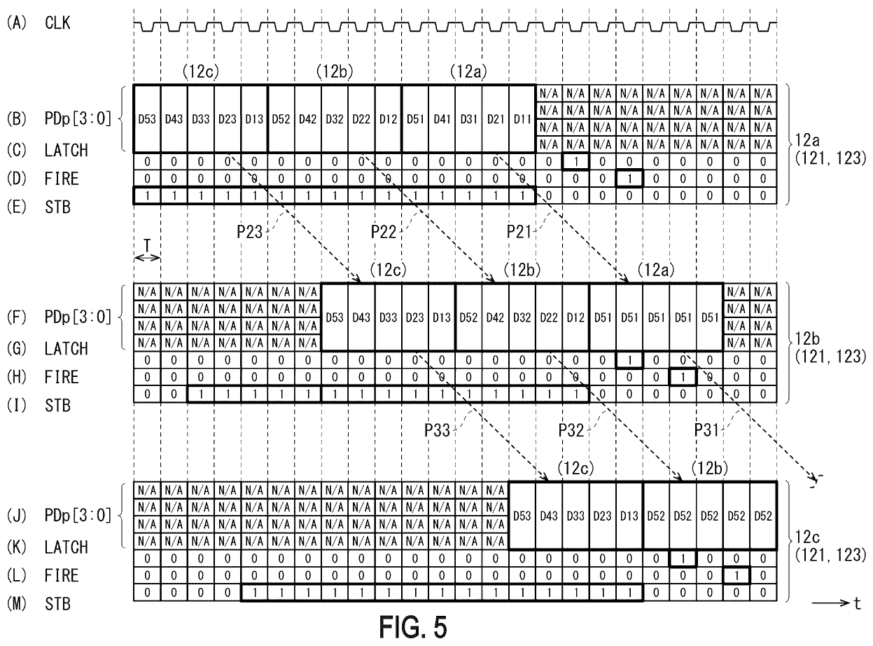

FIG. 3 is a timing chart schematically showing an operation example (a data transfer operation example) in each of the drive circuit units 12a, 12b, and 12c shown in FIG. 2, and FIG. 4 is a timing chart schematically showing a part of the operation example shown in FIG. 3 in an enlarged manner. Further, FIG. 5 is a timing chart schematically showing a data transfer operation in the whole of the inkjet head 1 shown in FIG. 1.

It should be noted that in FIG. 3 to FIG. 5 described above, the horizontal axis represents time t, and the same is applied to timing charts hereinafter described. Further, in FIG. 3 to FIG. 5, a single period of the clock signal CLK is shown as the period T, and the same is applied to the timing charts hereinafter described.

Here, in FIG. 3 and FIGS. 4, (A), (B), and (C) respectively represent the clock signal CLK, the serial data signal Ds, and 7-bit parallel data (including the 4-bit parallel pixel data signal PDp[3:0]) after the serial-to-parallel conversion is performed on the serial data signal Ds, which are input to (the serial-to-parallel conversion unit 121 in) each of the drive circuit units 12a, 12b, and 12c.

Meanwhile, in FIGS. 3, (D), (E), and (F) respectively represent the clock signal CLK, the serial data signal Ds, and the 7-bit parallel data (including the 4-bit parallel pixel data signal PDp[3:0]) before the parallel-to-serial conversion is performed, which are output from (the parallel-to-serial conversion unit 123 in) each of the drive circuit units 12a, 12b, and 12c.

Further, in FIG. 5, (A) represents the clock signal CLK, and (B) to (E), (F) to (I), and (J) to (M) respectively represent the 7-bit parallel data (including the 4-bit parallel pixel data signal PDp[3:0]) in the drive circuit units 12a, 12b, and 12c. Specifically, (B), (F), and (J) each represent the 4-bit parallel pixel data signal PDp[3:0], and (C), (G), and (K) each represent the latch signal LATCH. Further, (D), (H), and (L) each represent the firing signal FIRE, and (E), (I), and (M) each represent the strobe signal STB.

It should be noted that in FIG. 3 to FIG. 5, “n,” “a,” and “b” in “Dn_a_b” shown in the parallel pixel data signal PDp[3:0] each mean the following numbers. Further, “N/A” means invalid data (Not Available).
“n”: a bit number in the parallel pixel data signal PDp
“a”: a number of the nozzle hole Hn
“b”: a number in the plurality of drive circuit units (the three drive circuit units 12a, 12b, and 12c in this example) cascaded each other

Further, in FIG. 5, the expression of “Dab” is used instead of “Dn_a_b” defined above by collecting the contents of the respective bits in the 4-bit parallel pixel data signal PDp[3:0] and simplifying the symbols for the sake of convenience.

As shown in, for example, FIG. 3 and FIG. 4, the data transfer operation in the present embodiment is as follows in each of the drive circuit units 12a, 12b, and 12c. In other words, first, the serial data signal Ds includes the 7-bit serial data in the period (the single period) of the period T in synchronization with the clock signal CLK (see (A) in FIG. 3, (B) in FIG. 3, (A) in FIG. 4, and (B) in FIG. 4). By performing the serial-to-parallel conversion on the serial data signal Ds in the serial-to-parallel conversion unit 121, the 4-bit parallel pixel data signal PRp[3:0], the latch signal LATCH, the firing signal FIRE, and the strobe signal STB are generated (see the dotted arrows in FIG. 4). It should be noted that in this example, as shown in FIG. 4, the leading four bits in the serial data signal Ds are defined as the serial pixel data signal PDs, followed by the latch signal LATCH, the firing signal FIRE, and the strobe signal STB arranged in this order.

Here, only in a period (a period between the timings t11 to t16) in which the strobe signal STB generated in such a manner is STB=“1,” the shift clock (the logical AND signal Scom) is input to each of the D-FF circuits 41 in the shift register unit 122A. Therefore, this period becomes a valid period of the data input (input of the parallel pixel data signal PDp) to the shift register unit 122A (see (C) in FIG. 3 and (C) in FIG. 4).

In this period, first, the parallel pixel data signal PDp corresponding to the nozzle holes Hn1 to Hn5 is sequentially input to the shift register unit 122A. Subsequently, in the shift register unit 122A, the parallel pixel data signal PDp which is sequentially transferred and is held is held by each of the latch circuits 42 in the latch circuit unit 122B at the timing (timing t17) at which the latch signal LATCH changes from “0” to “1” (see (C) in FIG. 3). Subsequently, at the timing (timing t19) at which the firing signal FIRE changes from “0” to “1,” each of the waveform generation circuits 43 in the waveform generation circuit unit 122C starts the generation of the waveform signal to be the basis of the drive signal Sd based on the parallel pixel data signal PDp held in each of the latch circuits 42. Then, in the level conversion circuit 122D, the drive signal Sd corresponding to each of the nozzle hole Hn is generated based on such a waveform signal, and the drive walls described above are driven based on the drive signal Sd (as a result, for example, the ink 9 is ejected from each of the nozzle holes Hn) as a result (see the timings t19 to t20 in FIG. 1, FIG. 2, and FIG. 3).

Further, on this occasion, the 4-bit parallel pixel data signal PDp[3:0] output from the D-FF circuit 41 in the posteriormost stage of the shift register unit 122A is subjected to the parallel-to-serial conversion in the parallel-to-serial conversion unit 123. Specifically, by the parallel-to-serial conversion being performed based on the 4-bit parallel pixel data signal PDp[3:0], the latch signal LATCH, the firing signal FIRE, and the strobe signal STB, the serial data signal Ds described above is regenerated (see (D) to (F) in FIG. 3). Further, the serial data signal Ds regenerated in such a manner is output to the outside of the drive circuit units 12a, 12b, and 12c from the parallel-to-serial conversion unit 123 together with the clock signal CLK (see (D) and (E) in FIG. 3). It should be noted that at the timings t16 to t23 in “PDp[3:0]” (IN) in (C) in FIG. 3, since the strobe signal STB is set to STB=“0,” the sequential transfer described above is not performed. Therefore, as represented by the timings t18 to t23 in “PDp[3:0]” (OUT) in (F) in FIG. 3, it is arranged that “Dn_5_1” is kept unchanged in the parallel pixel data signal PDp[3:0].

It should be noted that on this occasion, the data is sequentially shifted as much as the period (corresponding to 7 periods) corresponding to seven periods T in a time period from the data input to the data output in each of the drive circuit units 12a, 12b, and 12c as represented by, for example, the dotted arrows P10, P11 in FIG. 3. Specifically, the parallel pixel data signal PDp included in the serial data signal Ds input in a period until the timing t11 is included in the serial data signal Ds and is output as a result in the period from the timing t13 to the timing t18 (see the dotted arrow P10). Similarly, the parallel pixel data signal PDp included in the serial data signal Ds input in a period from the timing t11 to the timing t16 is included in the serial data signal Ds and is output as a result in the period from the timing t18 to the timing t23 (see the dotted arrow P11).

Further, as shown in, for example, FIG. 5, the data transfer operation in the whole of the inkjet head 1 is as follows. That is, first, the 4-bit parallel pixel data signal PDp in the drive circuit unit 12a turns to the serial data signal Ds in such a manner as described above, and is output to the drive circuit unit 12b in the posterior stage of this drive circuit unit 12a (see the arrows P21 to P23 in FIG. 5). Similarly, the 4-bit parallel pixel data signal PDp in this drive circuit unit 12b turns to the serial data signal Ds in such a manner as described above, and is output to the drive circuit unit 12c in (the posteriormost stage) the posterior stage of this drive circuit unit 12b (see the arrows P31 to P33 in FIG. 5). It should be noted that also in FIG. 5 described above, in the period in which the strobe signal STB is set to STB=“0,” it is arranged that the sequential transfer described above is not performed, and “D_5_1” and “D_5_2” are kept unchanged in the parallel pixel data signal PDp[3:0].

It should be noted that on this occasion, it results in that the parallel pixel data signal PDp corresponding to each of the drive circuit units 12a, 12b, and 12c are sequentially transferred from the drive circuit unit 12a to the drive circuit units 12b, 12c while being sequentially shifted (see the arrows P21 to P23 and P31 to P33 in FIG. 5).

### (C. Regarding Occurrence of Abnormal State)

Incidentally, when generating such a drive signal Sd as described above, a variety of abnormal state related to the generation of the drive signal Sd may occur in some cases. Specifically, such abnormal states as described below may occur including the so-called redundant trigger state described above.
The redundant trigger state (the state in which the drive circuit units 12a to 12c receive the input data (the serial data signal Ds and the clock signal CLK) from the head control unit 2 within the generation period of the drive signal Sd)
An error state in a differential signal (e.g., an LVDS signal) for transmitting the serial data signal Ds and so on (a deviant state from a standard of a level, a state of a (1,1) pattern or a (0,0) pattern in the differential signal, and so on)
A state in which a cyclic redundancy check (CRC) error occurs in the serial data signal Ds and so on
A crash situation in an output analog switch (a multiplexer) in the waveform generation circuit 43

Further, as a cause for the occurrence of the redundant trigger state described above (a cause of receiving the input data once again in the generation period of the drive signal Sd), for example, the following can be cited. It should be noted that when, for example, the time interval of the drive signal Sd is set to just barely within the limit of the generation period of the drive waveform, there is a possibility that the drive waveform is issued before the completion of the generation of the drive waveform due to a jitter in an encoder or the like.
An occurrence of noise (A certain level of noise can be eliminated by confirming a pulse width in the drive signal Sd.)
An occurrence of jitter in the drive signal Sd (an output of the encoder for medium conveyance and so on)

Here, in a related-art common inkjet head, as described in detail in a comparative example described later, even when the occurrence of such an abnormal state as described above is detected when generating the drive signal Sd, the occurrence is ignored, and the occurrence of the abnormal state cannot be figured out in the outside (the print control unit 12). Therefore, in the past, there arises a necessity of calculating and setting the time interval (the time interval of the drive signal Sd) for avoiding the occurrence of such an abnormal state or a necessity of visually confirming by an image monitor or a human that the print quality on the printed object is not deteriorated.

In this way, in the related-art inkjet head, since the occurrence of the abnormal state when generating the drive signal Sd cannot be figured out in the outside, it is not easy to execute a variety of coping processing, and there is a possibility that the reliability of the inkjet head is damaged.

Therefore, in the inkjet head 1 according to the present embodiment, it is arranged that when an occurrence of such an abnormal state as described above is detected when generating the drive signal Sd, information (the status register Rs) representing that abnormal state is stored in the storage unit 125. Operation examples in the normal times and when an abnormal state occurs (abnormal times) will hereinafter be described in detail while comparing comparative examples (Comparative Examples 1 to 3) and practical examples (Practical Examples 1 to 3) of the present embodiment with each other.

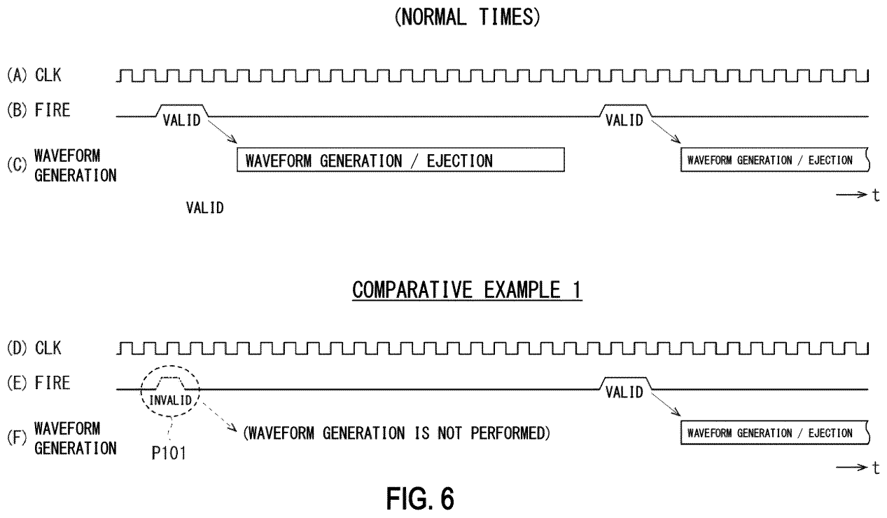

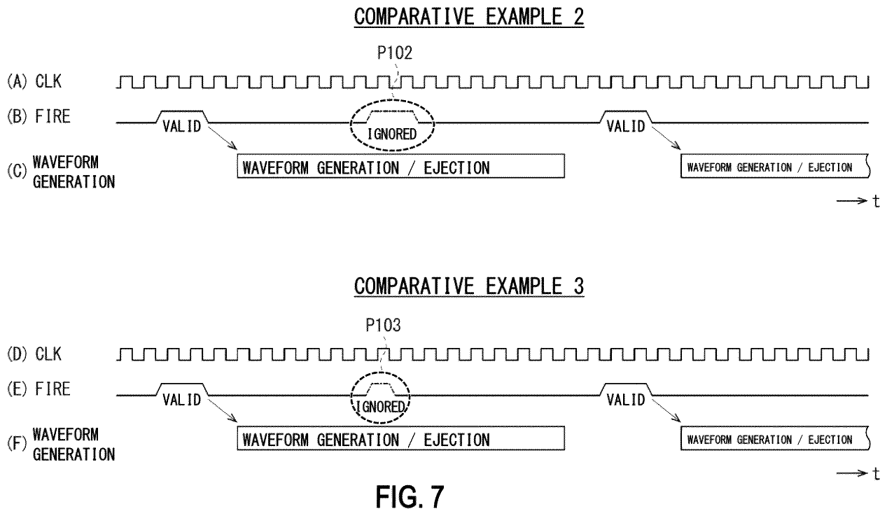

FIG. 6 is a diagram showing timing charts schematically illustrating an operation example ((A) to (C)) related to the normal times and an operation example ((D) to (F)) in the abnormal times according to Comparative Example 1, respectively. Further, FIG. 7 is a diagram showing timing charts schematically illustrating an operation example ((A) to (C)) in the abnormal times according to Comparative Example 2 and an operation example ((D) to (F)) in the abnormal times according to Comparative Example 3, respectively. Specifically, (A) in FIG. 6, (D) in FIG. 6, (A) in FIG. 7, and (D) in FIG. 7 each show the clock signal CLK, (B) in FIG. 6, (E) in FIG. 6, (B) in FIG. 7, and (E) in FIG. 7 each show the firing signal FIRE, and (C) in FIG. 6, (F) in FIG. 6, (C) in FIG. 7, and (F) in FIG. 7 each show a state of the waveform generation (and ejection of the ink 9) related to the drive signal Sd.

In contrast, FIG. 8 is a diagram showing timing charts schematically illustrating an operation example ((A) to (D)) in the abnormal times according to Practical Example 1 and an operation example ((E) to (H)) in the abnormal times according to Practical Example 2, respectively. Further, FIG. 9 is a timing chart schematically illustrating an operation example ((A) to (E)) in the abnormal times according to Practical Examples 3. Specifically, (A) in FIG. 8, (E) in FIG. 8, and (A) in FIG. 9 each show the clock signal CLK, and (B) in FIG. 8, (F) in FIG. 8, and (B) in FIG. 9 each show the firing signal FIRE. Further, (C) in FIG. 8, (G) in FIG. 8, and (C) in FIG. 9 each show the status register Rs described above, (D) in FIG. 8, (H) in FIG. 8, and (E) in FIG. 9 each show the state of the waveform generation (and ejection of the ink 9) related to the drive signal Sd, and (D) in FIG. 9 shows a FIRE (ejection request) reception temporary storage signal CLKt described later.

### (C-1. Operation Examples in Normal Times/Abnormal Times According to Comparative Examples 1 to 3)

First, in the operation example in the normal times shown in (A) to (C) in FIG. 6, when the firing signal FIRE becomes in a valid state (an “H” state) in the generation period of the drive signal Sd, the following occurs. That is, generation (waveform generation) of the drive signal Sd is started accordingly, and the ejection operation of the ink 9 based on the drive signal Sd thus generated is performed (see the solid arrows in FIG. 6).

In contrast, in the abnormal times (when the abnormal state occurs) according to Comparative Examples 1 to 3, the following operation is made.

First, in the operation example of the Comparative Example 1 shown in (D) to (F) in FIG. 6, since the pulse width of the firing signal FIRE generated in the generation period of the drive signal Sd is shorter than a specified time width, an invalid state is made (see the reference symbol P101 in FIG. 6). Therefore, in Comparative Example 1, it results in that the generation (the waveform generation) of the drive signal Sd is not performed (see the dotted arrow in FIG. 6).

Further, in both the operation example in Comparative Example 2 shown in (A) to (C) in FIG. 7 and the operation example in Comparative Example 3 shown in (D) to (F) in FIG. 7, the redundant trigger state described above occurs. In other words, in Comparative Examples 2, 3 described above, the input data from the head control unit 2 is received once again in the generation period of the drive signal Sd, and the firing signal FIRE occurs (see the reference symbols P102, P103 in FIG. 7). Incidentally, the firing signal FIRE in Comparative Example 3 is shorter in pulse width than the specified range similarly to the case of Comparative Example 1 described above, and is therefore also in the invalid state. Further, in each of Comparative Examples 2, 3 described above, it results in that such an occurrence of the firing signal FIRE is ignored, and the generation (the waveform generation) of the drive signal Sd is not performed.

As described above, in all Comparative Examples 1 to 3, since the occurrence of the abnormal state when generating the drive signal Sd cannot be figured out in the outside (the head control unit 2), it is not easy to execute a variety of coping processing, and there is a possibility that the reliability of the inkjet head and a whole of the apparatus is damaged.

### (C-2. Operation Examples in Abnormal Times According to Practical Examples 1 to 3)

In contrast, in Practical Examples 1 to 3 according to the present embodiment, since when an occurrence of such an abnormal state as described above is detected, the information (the status register Rs) representing the abnormal state described above is stored in the storage unit 125, the following occurs.

That is, first, in both the operation example in Practical Example 1 shown in (A) to (D) in FIG. 8 and the operation example in Practical Example 2 shown in (E) to (H) in FIG. 8, the redundant trigger state described above occurs similarly to the case of Comparative Examples 2, 3 described above. In other words, in Practical Examples 1, 2 described above, the input data from the head control unit 2 is received once again in the generation period of the drive signal Sd, and the firing signal FIRE occurs (see the reference symbols P41, P42 in FIG. 8). Incidentally, the firing signal FIRE in Practical Example 2 is shorter in pulse width than the specified time width similarly to the case of Comparative Examples 1, 3 described above, and is therefore also in the invalid state.

Here, in Practical Examples 1, 2 described above, unlike Comparative Examples 1 to 3 described above, when such an occurrence of the abnormal state when generating the drive signal Sd is detected by the detection unit 124, the information (the status register Rs) representing the abnormal state is stored in the storage unit 125. Specifically, as shown in each of (C) and (G) in FIG. 8, it results in that the status register Rs is set to Rs=1 (the “H” state), and the information of the status register Rs is obtained by the head control unit 2. In other words, there is adopted a configuration in which the information of the status register Rs stored in the storage unit 125 can be read (periodically) by the head control unit 2 as described above. Further, it is arranged that the notification unit 126 notifies the head control unit 2 of the information of the status register Rs stored in the storage unit 125 as described above. Further, as shown in each of (C) and (G) in FIG. 8, when the head control unit 2 obtains the information of the status register Rs in such a manner, the head control unit 2 executes, for example, predetermined recovery processing (error recovery processing) for recovering from such an abnormal state.

Further, in the operation example in Practical Example 3 shown in (A) to (E) in FIG. 9, when the firing signal FIRE occurs, the FIRE reception temporary storage signal CLKt ((D) in FIG. 9) becomes in the “H” state (see the arrows P431, P435 in FIG. 9). Further, it is arranged that the generation operation of the drive signal Sd and the ejection operation of the ink 9 are started in accordance therewith (see the arrows P432, P436 in FIG. 9).

Also in Practical Example 3, similarly to Practical Examples 1, 2 described above, when an occurrence of the abnormal state (the redundant trigger state or the like) when generating the drive signal Sd is detected by the detection unit 124, the information (the status register Rs) representing the abnormal state is stored in the storage unit 125. Specifically, as shown in (C) and the arrow P434 in FIG. 9, the status register Rs is set to Rs=1 (the “H” state), and the information of the status register Rs is obtained by the head control unit 2 using substantially the same method in Practical Examples 1, 2. Further, similarly to Practical Examples 1, 2, when the head control unit 2 obtains the information of the status register Rs, the head control unit 2 executes, for example, predetermined recovery processing (error recovery processing) for recovering from such an abnormal state (see (C) in FIG. 8).

Further, in Practical Example 3, unlike the cases of Practical Examples 1, 2 described above, when the occurrence of the redundant trigger state is detected by the detection unit 124 (see the reference symbol P433 in FIG. 9), it is arranged that the generation operation of the drive signal Sd and so on by the drive signal generation unit 122 are also performed in the following manner. Specifically, when the input data from the head control unit 2 is received once again in the generation period of the drive signal Sd and the firing signal FIRE is generated, the status register Rs is stored, and the generation operation of the drive signal Sd and the ejection operation of the ink 9 are each started using the FIRE reception temporary storage signal CLKt described above (see the arrows P432, P436 in FIG. 9). On this occasion, the drive signal generation unit 122 performs the generation of the subsequent drive signal Sd (see the arrow P436 in FIG. 9) based on the input data (the serial data signal Ds and the clock signal CLK) received (re-received) within the generation period of the present drive signal Sd after the generation period of the present drive signal Sd ends.

Further, when the generation of the subsequent drive signal Sd is performed based on the input data which is received within the generation period of the present drive signal Sd in such a manner, it is arranged that error information representing this fact is obtained by the head control unit 2 (see (E) in FIG. 9). In other words, it is configured that, for example, such error information can be read out by the head control unit 2. Alternatively, it is arranged that, for example, the notification unit 126 notifies the head control unit 2 of such error information. This makes it possible to, for example, prompt the head control unit 2 to correct parameter setting and so on.

### (D. Functions/Advantages)

In this way, in the inkjet head 1 according to the present embodiment, when the abnormal state described above related to the generation of the drive signal Sd based on the input data (the serial data signal Ds and the clock signal CLK) supplied from the external head control unit 2 is detected, the information (the status register Rs) representing that abnormal state is stored in the storage unit 125. Thus, even when such an abnormal state occurs, the occurrence of that abnormal state is not ignored but is stored as the status register Rs, and therefore, it becomes possible to use that status register Rs for a variety of coping processing. As a result, in the present embodiment, it becomes possible to improve the reliability of the inkjet head 1.

Further, in the present embodiment, since it is configured that the status register Rs stored in the storage unit 125 can be read out by the head control unit 2, it becomes possible for the external head control unit 2 to figure out the information related to the occurrence of such an abnormal state as described above. Therefore, in the present embodiment, it becomes possible to improve the convenience.

Further, in the present embodiment, since it is arranged that the notification unit 126 notifies the head control unit 2 of the information of the status register Rs stored in the storage unit 125, the following is achieved. That is, it becomes possible to easily figure out the information related to the occurrence of such an abnormal state as described above in the external head control unit 2. Therefore, in the present embodiment, it becomes possible to further improve the convenience.

In addition, in the present embodiment, when it is arranged that when the occurrence of the redundant trigger state described above is detected, generation of the subsequent drive signal Sd is performed based on the input data, which is received within the generation period of the present drive signal Sd, after the generation period of the present drive signal Sd ends, the following is achieved. That is, since the input data, which is received when such a redundant trigger state occurs, is also used for the generation of the drive signal Sd, it becomes possible to enhance the convenience.

Further, in the present embodiment, when it is configured that when the generation of the subsequent drive signal Sd is performed based on the input data which is received within the generation period of the present drive signal Sd in such a manner as described above, the information of the error state representing this fact can be read out by the head control unit 2, the following is achieved. That is, since it becomes possible to figure out the fact that the generation of the subsequent drive signal Sd is performed in such a manner as described above in the external head control unit 2 (to prompt the correction of the parameter setting and so on), it becomes possible to enhance the convenience.

Further, in the present embodiment, when it is arranged that when the generation of the subsequent drive signal Sd is performed based on the input data which is received within the generation period of the present drive signal Sd in such a manner as described above, the notification of that fact is given to the head control unit 2 by the notification unit 126, the following is achieved. That is, since it becomes possible to easily figure out the fact that the generation of the subsequent drive signal Sd is performed in such a manner as described above in the external head control unit 2 (to easily prompt the correction of the parameter setting and so on), it becomes possible to further enhance the convenience.

In addition, in the present embodiment, when it is arranged that a predetermined recovery processing for recovering from the abnormal state described above is executed when the information of the status register Rs stored in the storage unit 125 is acquired in the head control unit 2, the following is achieved. That is, since the recovery processing for recovering from such an abnormal state is executed, it becomes possible to further improve the reliability of the inkjet head 1.

### 2. Modified Examples

The present disclosure is described hereinabove citing the embodiment and some practical examples, but the present disclosure is not limited to the embodiment and so on, and a variety of modifications can be adopted.

For example, in the embodiment and so on described above, the description is presented specifically citing the configuration examples (the shapes, the arrangements, the number and so on) of each of the members in the printer 3 and the inkjet head 1, but what is described in the above embodiment and so on is not a limitation, and it is possible to adopt other shapes, arrangements, numbers and so on. Specifically, in the embodiment and so on described above, an example when the plurality of nozzle holes Hn are provided to each of the jet sections 11a to 11c in the inkjet head 1 is described, the example in this case is not a limitation. That is, when the present disclosure is applied to, for example, a so-called 3D printer, it is possible to arrange that just one nozzle hole Hn is provided alone to each of the jet sections 11a to 11c.

Further, a variety of types of structures can be adopted as the structure of the inkjet head. Specifically, it is possible to adopt, for example, a so-called side-shoot type inkjet head which ejects the ink 9 from a central portion in the extending direction of each of the ejection channels in the piezoelectric actuator 111. Alternatively, it is possible to adopt, for example, a so-called edge-shoot type inkjet head for ejecting the ink 9 along the extending direction of each of the ejection channels. Further, the type of the printer is not limited to the type described in the embodiment and so on described above, and it is possible to apply a variety of types such as a thermal type (a bubble jet (registered trademark) type), a micro electro-mechanical systems (MEMS) type, a direct thermal type, and a dot impact type.

Further, for example, it is possible to apply the present disclosure to either of an inkjet head of a circulation type which uses the ink 9 while circulating the ink 9 between an ink container and the inkjet head, and an inkjet head of a non-circulation type which uses the ink 9 without circulating the ink 9.

In addition, in the embodiment and so on described above, the description is presented specifically citing the example of the data transfer method, but the example cited in the embodiment and so on described above is not a limitation, and it is also possible to arrange to perform the data transfer using other methods. Specifically, for example, in the embodiment and so on described above, the example when the data transfer using the serial data signal Ds is performed, and the serial-to-parallel conversion and the parallel-to-serial conversion are performed in each of the drive circuit units 12a to 12c is described, but the example in this case is not a limitation. That is, it is possible to arrange that, for example, the data transfer using a parallel data signal is performed. Further, for example, in the data transfer method with a so-called “8B/10B system,” it is possible to apply the method of the present disclosure by providing an 8B/10B decoder, an encoder, and a protocol control circuit.

Further, the series of processing described in the above embodiments and so on can be arranged to be performed by hardware (a circuit), or can also be arranged to be performed by software (a program). When it is arranged that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the embodiment and so on described above, the description is presented citing the printer 3 (the inkjet printer) as a specific example of the “liquid jet recording apparatus” in the present disclosure, but this example is not a limitation, and it is also possible to apply the present disclosure to other apparatuses than the inkjet printer.

In other words, it is also possible to arrange that the “liquid jet head” (the inkjet head) of the present disclosure is applied to other apparatuses than the inkjet printer. Specifically, it is also possible to arrange that the “liquid jet head” according to the present disclosure is applied to an apparatus such as a so-called 3D printer, a facsimile, or an on-demand printer.

In addition, it is also possible to apply the variety of examples described hereinabove in arbitrary combination.

It should be noted that the advantages described in the present specification are illustrative only, but are not a limitation, and other advantages can also be provided.

Further, the present disclosure can also take the following configurations.

A liquid jet head including a jet section including a single nozzle or a plurality of nozzles configured to jet a liquid, and a single drive circuit unit or a plurality of drive circuit units configured to generate a drive signal for jetting the liquid from the nozzle based on input data supplied from an external head control unit, and output the drive signal to the jet section, wherein the drive circuit unit includes a signal generation unit configured to generate the drive signal based on the input data, a detection unit configured to detect presence or absence of an occurrence of an abnormal state related to generation of the drive signal, and a storage unit configured to store information representing the abnormal state when the occurrence of the abnormal state is detected by the detection unit.

The liquid jet head described in (1) above, wherein the information representing the abnormal state stored in the storage unit is configured to be read out by the head control unit.

The liquid jet head described in (1) or (2) above, wherein the drive circuit unit further includes a notification unit configured to give a predetermined notification, and the notification unit is configured to notify the head control unit of the information representing the abnormal state stored in the storage unit.

The liquid jet head described in any one of (1) to (3) above, wherein the abnormal state is a state in which the input data is received from the head control unit in a generation period of the drive signal.

The liquid jet head described in (4) above, wherein when the occurrence of the state in which the input data is received from the head control unit in the generation period of the drive signal is detected by the detection unit, the signal generation unit performs generation of a subsequent drive signal based on the input data received in the generation period of the drive signal after the generation period of the present drive signal ends.

The liquid jet head described in (5) above, wherein the drive circuit unit further includes a notification unit configured to give a predetermined notification, and when the generation of the subsequent drive signal is performed based on the input data received in the generation period of the present drive signal, the notification unit gives, to the head control unit, a notification that the generation of the subsequent drive signal is performed based on the input data received in the generation period of the present drive signal.

The liquid jet head described in (5) or (6) above, wherein when the generation of the subsequent drive signal is performed in the signal generation unit based on the input data received in the generation period of the present drive signal, information of an error state representing that the generation of the subsequent drive signal is performed based on the input data received in the generation period of the present drive signal is configured to be read out by the head control unit.

A liquid jet recording apparatus including the liquid jet head described in any one of (1) to (7) above, and the head control unit.

The liquid jet recording apparatus described in (8) above, wherein when the head control unit acquires the information representing the abnormal state stored in the storage unit, the head control unit executes predetermined recovery processing for recovering from the abnormal state.

What is claimed is:

1. A liquid jet head comprising:
a jet section including a single nozzle or a plurality of nozzles configured to jet a liquid; and
a single drive circuit unit or a plurality of drive circuit units configured to generate a drive signal for jetting the liquid from the nozzle based on input data supplied from an external head control unit, and output the drive signal to the jet section, wherein
the drive circuit unit includes
a signal generation unit configured to generate the drive signal based on the input data,
a detection unit configured to detect presence or absence of an occurrence of an abnormal state related to generation of the drive signal, and
a storage unit configured to store information representing the abnormal state when the occurrence of the abnormal state is detected by the detection unit.

2. The liquid jet head according to claim 1, wherein
the information representing the abnormal state stored in the storage unit is configured to be read out by the head control unit.

3. The liquid jet head according to claim 1, wherein
the drive circuit unit further includes a notification unit configured to give a predetermined notification, and
the notification unit is configured to notify the head control unit of the information representing the abnormal state stored in the storage unit.

4. The liquid jet head according to claim 1, wherein
the abnormal state is a state in which the input data is received from the head control unit in a generation period of the drive signal.

5. The liquid jet head according to claim 4, wherein
when the occurrence of the state in which the input data is received from the head control unit in the generation period of the drive signal is detected by the detection unit, the signal generation unit performs generation of a subsequent drive signal based on the input data received in the generation period of the drive signal after the generation period of the present drive signal ends.

6. The liquid jet head according to claim 5, wherein
the drive circuit unit further includes a notification unit configured to give a predetermined notification, and
when the generation of the subsequent drive signal is performed based on the input data received in the generation period of the present drive signal, the notification unit gives, to the head control unit, a notification that the generation of the subsequent drive signal is performed based on the input data received in the generation period of the present drive signal.

7. The liquid jet head according to claim 5, wherein
when the generation of the subsequent drive signal is performed in the signal generation unit based on the input data received in the generation period of the present drive signal, information of an error state representing that the generation of the subsequent drive signal is performed based on the input data received in the generation period of the present drive signal is configured to be read out by the head control unit.

8. A liquid jet recording apparatus comprising:
the liquid jet head according to claim 1; and
the head control unit.

9. The liquid jet recording apparatus according to claim 8, wherein
when the head control unit acquires the information representing the abnormal state stored in the storage unit, the head control unit executes predetermined recovery processing for recovering from the abnormal state.
